(19) United States
(12) Patent Application Publication
(10) Pub. No.: US 2010/0029273 A1
(43) Pub. Date: Feb. 4, 2010

(54) Free Agent Telephony

(75) Inventor: James D. Bennett, Hroznetin (CZ)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/265,041

(22) Filed: Nov. 5, 2008

Related U.S. Application Data
(60) Provisional application No. 61/086,127, filed on Aug. 4, 2008.

(51) Int. Cl. H04W 60/00

(52) U.S. Cl. 455/435.2

(57) ABSTRACT

A wireless phone has a communication application that enables the phone to retain a phone number used in a first network when the phone switches association from the first network to a second network. Switching of network association by the phone is triggered by a user input entered via a user input interface of the phone. The phone directs the first network to not release the phone number upon disassociation of the phone from the first network, sends the phone number to the second network, directs the second network to identify the phone in second network by the phone number, and triggers the second network to attach a tag corresponding to the second network to the phone number and enter the tagged phone number in a central database. In another embodiment a subscriber identity module (SIM) enables the phone to use the communication application for phone number porting.

### CROSS REFERENCES TO RELATED APPLICATIONS

The present application claims priority under 35 U.S.C. 119(e) to U.S. Provisional Application Ser. No. 61/086,127, filed Aug. 4, 2008, and having a common title with the present application, which is incorporated herein by reference in its entirety for all purposes.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

1. Field of the Invention

The present invention relates generally to the cellular telephony and more particularly to the association of a cellular telephone with differing service providers.

2. Description of the Related Art

In conventional cellular telephone networks, a cellular phone is assigned a phone number (often based upon a Subscriber Identity Module (SIM)) when the phone registers with a phone service provider or phone network. The network with which the telephone/SIM card registers is called the phone's home network. The phone can be reached from the home network or any other phone network by dialing the assigned phone number. A cellular phone is typically allowed to access other cellular networks when the cellular phone moves to a location that does not have coverage from the home network. However the cellular phone is often charged a higher than normal rate for a call using differing cellular phone infrastructure in spite of being registered with the home network.

A cellular phone owner may register the phone with another network if it is unlocked and de-register from the home network. In such case the other network issues a new phone number to the cellular phone, often times requiring that a new SIM card be installed in the phone. The phone is charged normal rate for a call as the cellular phone has become a resident of the other network and can be reached by dialing the new phone number but cannot be reached using the original phone number. The cellular phone has yet another option of registering with the other network and requesting the other network to port the phone number issued by the home network. In the yet another option the cellular phone can be reached in the other network by dialing the old phone number, i.e., the number that the phone used in the home network with supporting registration operations/settings. A fixed line phone is also adapted to switch to a new phone network. It has two options: either to use s new phone number in the new phone network or to request the new phone network for phone number porting. However number porting is a task performed by service providers and it typically takes up to five working days by service providers to port a phone number from one network to another.

Further limitations and disadvantages of conventional and traditional approaches will become apparent to one of ordinary skill in the art through comparison of such systems with various aspects of the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

For various aspects of the present invention to be easily understood and readily practiced, various aspects will now be described, for purposes of illustration and not limitation, in conjunction with the following figures:

FIG. 1 is a system diagram illustrating a phone network having a network switching application that allows a phone to retain its number while switching from a current network to another network of a plurality of available networks using the network switching application in accordance with various aspects of the present invention;

FIG. 2 is a diagram illustrating a cellular phone having a number porting application, the cellular phone altering service from one operator to another operator without changing a cellular phone number by way of using the number porting application while moving from location A to location B;

FIG. 3 is a schematic block diagram illustrating components present in a cellular phone that supports switching between cellular service providers and retaining a cellular phone number obtained from a home network;

FIG. 4 is a schematic block diagram illustrating a plurality of components of a cellular phone and a removable Subscriber Identity Module (SIM) that includes a network switching application, the SIM when plugged into the cellular phone enables the cellular phone to switch between cellular service providers without changing cellular phone number by using a network switching application of the SIM;

FIG. 5 is a flow chart illustrating operations of a network switch in processing a plurality of requests received from a phone that is adapted to initiate porting of a phone number while switching from a phone network to another phone network;

FIG. 6 is a flow chart illustrating operations supporting routing pathway of an incoming call to a ported phone;

FIG. 7 is a block diagram illustrating a cellular phone having a first SIM that is used by the cellular phone to access a home network using a home phone number and a second SIM that enables the cellular phone to access another network using the home phone number; and

FIG. 8 is a flow chart illustrating a method for retaining a phone number used in home network while switching from a current network to another network.

### DETAILED DESCRIPTION OF THE DRAWINGS

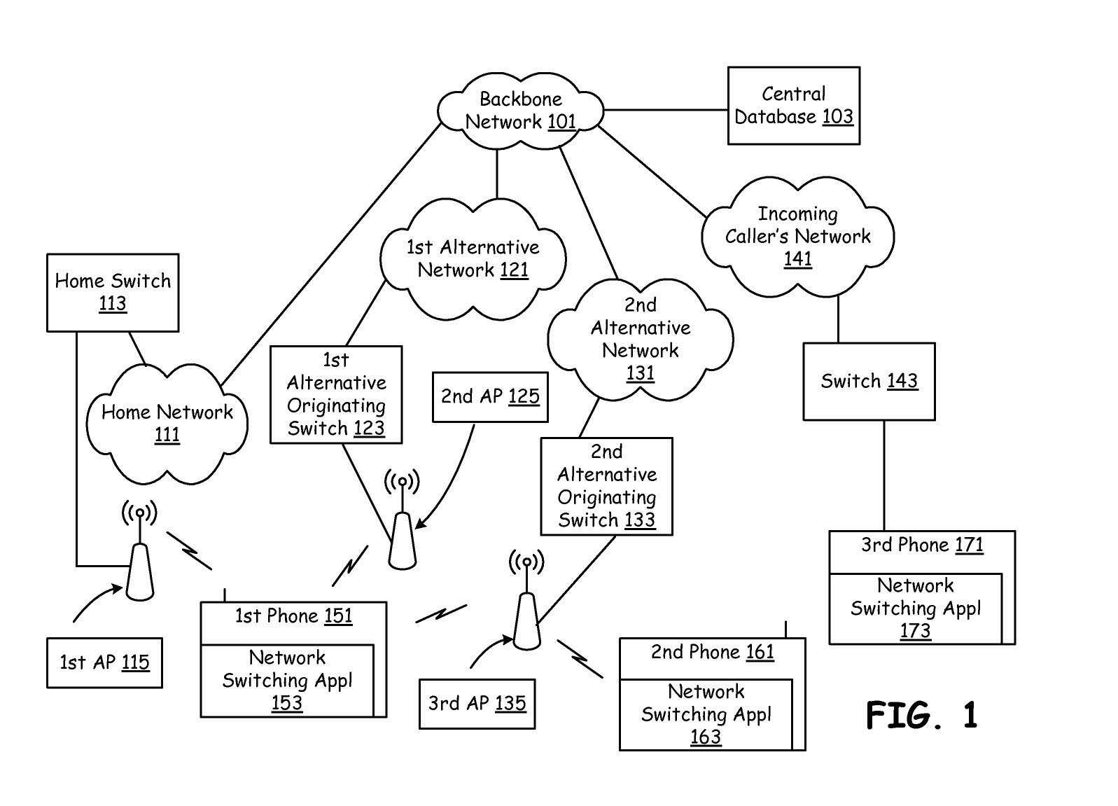

FIG. 1 is a system diagram illustrating a phone network having a network switching application that allows a phone to retain its number while switching from a current network to another network of a plurality of available networks using the network switching application in accordance with various aspects of the present invention. The system of FIG. 1 includes a phone (151, 161, or 171) having a network switching application (153, 163 or 173), the phone retaining its number while switching from a current network to another network wherein the phone (151, 161, or 171) selects another network from a plurality of available networks using the network switching application (153, 163 or 173). A first phone 151 is a wireless phone that communicates with a first access point (AP) 115 of home network 111 via a wireless transceiver (not shown here) on the first phone 151. The first phone 151 is a cellular telephone that supports the GSM or CDMA standard(s) for example, a Wireless Wide Area Network (WWAN, e.g., WiMAX) telephone, or another type of wireless telephone that couples to a supporting network infrastructure via an AP. The AP may be a WWAN AP or a cellular network AP, e.g., base station. The first phone 151 receives a phone number or a subscriber identity number and a mobile handset identification number from the home network 111 via the wireless transceiver when the first phone 151 registers with the home network 111. The phone number or the subscriber identity number is dialed by a calling party to reach the first phone 151. The mobile handset identification number uniquely identifies the first phone handset 151 in the home network 111. A call originating at the first phone 151 and incoming calls to the first phone 151 are routed via a home switch 113. The first phone 151 is communicatively coupled to the home switch 113 via the first AP 115.

The home switch 113 is communicatively coupled to a central database 103 via a backbone network 101. The central database is a repository that stores phone numbers and network identifications of current networks of phones that have been ported to other networks, i.e., the phones that are currently attached to networks other than their home networks and use the phone numbers assigned by their home networks while accessing services provided by the other networks. A home network of a phone refers to the network with which the phone is registered. The phone receives its phone number or subscriber identity number from its home network. The phone can be reached by a calling party by dialing the phone number.

The phone has two options when the phone switches to a new network i.e., detaches from the home network and attaches to the new network. A first of the two options is to receive a new phone number from the new network. A calling party dials the new phone number to reach the phone attached to the new network. A second of the two options is to retain the phone number issued by the home network. A calling party need not be made aware of migration of the phone to the new network if the phone chooses the second option. The home switch 113, for a call originating at the first phone 151, sends a number dialed by the first phone 151 to the central database 103. The central database 103 returns network identification of network to which the dialed phone is currently attached if the dialed phone has ported to the current network. The home switch 113, using the network identification returned by the central database 103, routes the call originating at the first phone 151. The central database 103 returns null if the dialed phone has not been ported. The home switch 113 determines network identification of the dialed phone using the dialed number and routes the call to the dialed phone.

The first phone 151 is located in an area that is simultaneously served by the home network 111, a first alternative network 121, and a second alternative network 131. The wireless transceiver of the first phone 151 supports a wireless communication protocol (GSM, CDMA, and/or WiMAX). The home network 111, the first alternative network 121 and the second alternative network 131 operate according to the wireless communication protocol. The first phone 151 includes a network switching application 153. The first phone 151 searches for available networks other than the home network 111 using the network switching application 153. The first phone 151 detects presence of the first alternative network 121 and the second alternative network 131. The first phone 151 is in addition adapted to discover network parameters of the first alternative network 121 and the second alternative network 131. The network parameters typically include one or more of a receive signal quality, supported data rate, call cost etc. The first phone 151, based on network parameters of the home network 111, the first alternative network 121 and the second alternative network 131, decides either to remain attached to the home network 111 or to switch to one of the first alternative network 121 and the second alternative network 131.

For example, and without limitation, the network switching application 153 of the first phone 151 decides to switch to the first alternative network 121. The home network 111, the first alternative network 121 and the second alternative network 131 may operate in different frequency bands. The transceiver of the first phone 151, triggered by the network switching application 153, sends a network attachment request to the first alternative network 121 by operating the wireless transceiver (not shown here) on the first phone 151 in a frequency band used by the first alternative network 121. On receiving an attachment grant message from the first alternative network 121 via the second AP 125, the first phone 151, on being triggered by the network switching application 153, sends a phone number retention request to the home network 111. On receiving a number retention grant message from the home network 111, the first phone 151 detaches from the home network 111 and attaches to the first alternative network 121. The number retention grant message ensures that the home network 111 does not assign the phone number used by the first phone 151 in the home network 111 to other phones. The network switching application 153 directs the transceiver of the first phone 151, in order to retain the phone number that the first phone 151 uses in the home network 111, to send the phone number and a number porting request to the first alternative network 121.

In response to the number porting request, the first alternative network 121 assigns a new mobile handset identification number to the first phone 151 and a first alternative switch 123 enters the phone number of the first phone 151 in the central database 103. The first alternative switch 123 is communicatively coupled to the central database via the backbone network 101 and the first alternate network 121. The central database 103 associates the phone number of the first phone 151 with the first alternative switch 123, thereby indicating that the first phone 151 has been ported to the first alternative network 121. The first phone 151, after attaching to the first alternative network 121, accesses services provided by the first alternative network 121 using the phone number and the new mobile handset identification number. Callers reach the first phone 151 by dialing the phone number issued by the home network 111 to the first phone 151 even after the first phone 151 switches from the home network 111 to the first alternative network 121.

As a way of example, a third phone 171 (i.e., a user using the third phone 171) dials the phone number of the first phone 151. The third phone 171 is a wired phone. The switch 143 that is communicatively coupled to the central database 103 via the backbone network 101 sends the phone number of the first phone 151 to the central database 103. The central database 103 returns network identification of the first alternative network 121 to the switch 143 thereby informing the switch 143 that the first phone 151 is currently attached to the first alternative network 121. The switch 143 forwards the call originating at the third phone 171 to the first alternative network 121 via the backbone network 101. Call incoming from the third phone 171 reaches the first phone 151 via the first alternative originating switch 123 and the second AP 125. Switching of network by the first phone 151 remains oblivious to the third phone 171.

The network switching application 153 of the first phone 151 may be triggered manually. In another embodiment there is an upper limit on number of times the network switching application can be triggered manually in a month, thereby ensuring that a user does not port his phone number too often. The network switching application 153 of the first phone 151 gets triggered when the first phone is attached to the first alternative network 121 via the second AP 125. The network switching application 153 searches for available networks and decides to switch to the second alternative network 131. The network switching application 153 directs the first phone to go through following steps. The first phone 151 sends a network attachment request to the second alternative network 131. Upon receiving an attachment grant request, the first phone 151 sends the phone number to the second alternative network 131 along with a number porting request. In response to the number porting request a second alternative originating switch 133 enters the phone number of the first phone 151 in the central database 103. The central database 103 associates the phone number of the first phone 151 with the second alternative switch 133, thereby indicating that the first phone 151 has been ported to the second alternative network 131. The first phone detaches from the first alternative network 121 and attaches with the second alternative network 131. Calls originated by the first phone 151 and incoming calls to the first phone 151 are routed via the second alternative switch 133.

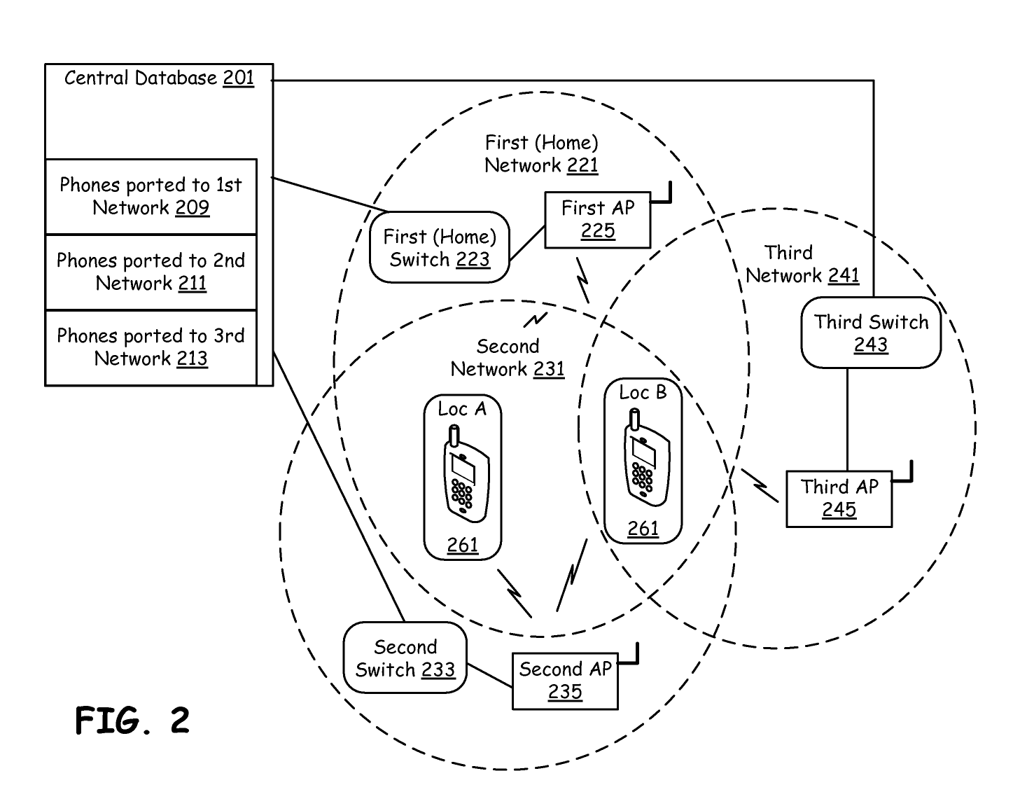

FIG. 2 is a diagram illustrating a cellular phone having a number porting application, the cellular phone altering service from one operator to another operator without changing a cellular phone number by way of using the number porting application while moving from location A to location B. With the system of FIG. 2, a cellular phone 261 includes a number porting application, the cellular phone 261 switching from one operator to another operator without changing cellular phone number while moving from location A to location B by way of using the number porting application. The cellular phone 261 is located in position A at a first time. The cellular phone 261 is attached to a first cellular network 221 which is the home network of the cellular phone 261. The cellular phone 261 receives the cellular phone number from the first network 221 via a first access point (AP) 225. Calls originating from the cellular phone 261 and incoming calls to the cellular phone 261 are routed by a first switch 223. The cellular phone number includes a field that indicates identity of network from which the cellular phone 261 receives the cellular phone number.

In an infrastructure that does not support number portability, every time the cellular phone 261 registers with a new network, the cellular phone 261 receives a new phone number from the new network, such that the field in the phone number always reveals identity of the network to which the cellular phone 261 is currently attached. Calls incoming to the cellular phone 261 thereby get routed to a switch of the new network i.e., the network to which the cellular phone 261 is currently attached. An infrastructure that supports number portability i.e., present embodiment of the invention, includes a central database 201 that stores phone numbers of cellular phones that have been ported to other networks. The first switch 223, a second switch 233 of a second network 231 and a third switch 243 of a third network 241 are communicatively coupled to the central database 201. The first switch 223, the second switch 233 and the third switch 243 send phone numbers of calls originating from the first network 221, the second network 231, and the third network 241 respectively to the central database 201. The central database 201 returns network identifications of networks to which the phones corresponding to the phone numbers are currently attached if the phones have been ported. The first switch 223, the second switch 233, and the third switch 243, using the network identifications returned by the central database 201 forward the originating calls to the networks to which the phones are currently attached. The central database 201 returns null if the phones are not ported. The switch 223, the second switch 233, and the third switch 243 use the phone numbers of the originating calls to determine networks to which the phones are currently attached.

The number porting application of the cellular phone 261 may be software that when activated directs the cellular phone 261 to: (a) search for available networks, (b) select a network from the available networks, (c) request a home network to retain a phone number if the selected network is different from the home network, (d) detach from current network if the selected network is different from current network, (e) attach to the selected network if step (d) is successful, and (f) port the phone number to selected network if the selected network is different from home network. The number porting application may be triggered manually. As an example, the number porting application of the cellular phone 261 is triggered when the cellular phone 261 is at location A. The cellular phone 261 searches for available networks and finds the first network 221 and the second network 231 to be available. The cellular phone 261 selects one of the first network 221 and the second network 231 based on selection criteria. The selection criteria include one or more of a received signal quality, data rate supported by a network, call cost in a network etc. The cellular phone 261 receives the data rate supported by a network and the call cost in the network from the network while searching for availability of networks.

As an example of these operations, the cellular phone 261 selects the second network 231. The cellular phone 261 sends an access grant request to the second network 231 via the first AP 225. On receiving an access grant message from the second network 231 via the first AP 225, the cellular phone 261 sends a phone number retention request to the first network 221 via the first AP 225. On receiving a retention grant message from the first network 221 via the first AP 225, the cellular phone 261 detaches from the home network 221. The cellular phone 261 attaches with the second AP 235, notified by an access grant message received from the second network 231. In an embodiment the access grant message received from the second network 231 includes a mobile identification number that uniquely identifies the cellular phone 261 in the second network 231. Upon attaching with the second AP 235 the cellular phone 261 sends the cellular phone number to the second AP 235 along with a number porting request. In response to the number porting request the second AP 235 forwards the cellular phone number to the second switch 233. The second switch 233 enters the cellular phone number in a database corresponding to numbers that have been ported to the second network 231 in the central database 201. The cellular phone 261, while at location A, accesses services provided by the second network 231 by using the cellular phone number that the cellular phone 261 received from the first network 221 i.e., the home network of the cellular phone 261.

At a second time the cellular phone 261 moves to location B. The cellular phone 261 continues to remain attached to the second network 231 as the cellular phone 261 moves from location A to location B. The number porting application of the cellular phone 261 gets triggered when the cellular phone 261 is in location B. The location B is served by the first network 221, the second network 231, and the third network 241. The cellular phone 261 detects presence of the first network 221, the second network 231, and the third network 241 at the location B. For example and without limitation, the cellular phone 261 selects the first network 221. The cellular phone 261 sends an attachment request to the first network 221 via the second AP 235. On receiving an access grant message from the first network via the second AP 235, the cellular phone 261 detaches from the second AP 235 and attaches with the first AP 225 using the access grant message received from the first network 221. The cellular phone 261 sends the cellular phone number and a number porting request to the first network 221 via the first AP 225. The first network identifies the cellular phone 261 as its home phone from the cellular phone number. The first switch 223 does not enter the phone number of the cellular phone 261 in the central database 201 because the first network 221 is the home network of the cellular phone 261. The second switch 233 of the second network 231 removes entry corresponding to the cellular phone 261 from the central database 201.

At a third time the number porting application of the cellular phone 261 gets triggered. The cellular phone 261 selects the third network 241 based on the network selection criterion. The cellular phone 261 goes through following steps: sending a network access request to the third network 241, receiving an access grant message from the third network 241, sending a phone number retention request to the first network 221, detaching from the first network 221, attaching to the third network 241 via the third AP 245, sending a number porting request to the third network 241 and phone number of the cellular phone 261.

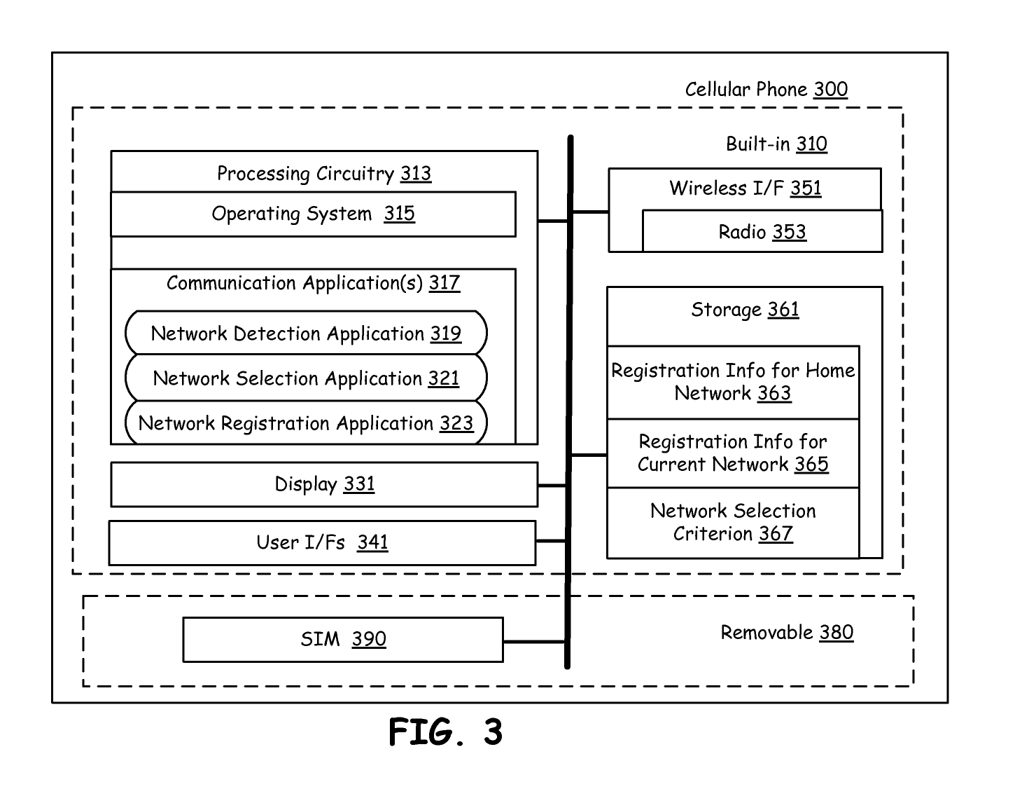

FIG. 3 is a schematic block diagram illustrating components present in a cellular phone that supports switching between cellular service providers and retaining a cellular phone number obtained from a home network. The cellular phone 300 supports switching between cellular service providers and retaining a phone number obtained from home network while switching between the cellular service providers. The cellular phone 300 receives the phone number from the home network when the cellular phone registers with the home network. The cellular phone 300 can be reached by dialing the phone number. If the cellular phone 300 moves to a location that is not serviced by the home network but by the another cellular network, the cellular phone 300 has an option of registering with the other network and requesting the other network to port the phone number issued by the home network. If the other network ports the phone number of the cellular phone 300, then the cellular phone 300 can be reached in the other network by dialing the phone number issued by the home network. Switching of the cellular phone 300 from the home network to the other network remains oblivious to people reaching the cellular phone 300. In the present embodiment the cellular phone 300 includes processing circuitry 313, an operating system 313, and a communication application 317 that enables the cellular phone 300 to perform and manage number porting when the cellular phone 300 switches to the other network. The cellular phone 300 further includes a display 331, one or more user interfaces 341, and a removable portion 380 that can store a SIM 390.

The additional components present in the cellular phone 300 to enable the cellular phone 300 to perform and manage number porting are the communication application 317 which is a software, network selection criteria 367 which are a plurality of rules and registration information for the home network 363 and registration information for current network 365, network with which the cellular phone 300 is currently attached. The cellular phone 300 stores the network selection criterion 367, the registration information for the home network 363, and registration information for current network 365 in storage 361. The cellular phone 300 receives the registration information for the home network 363 and registration information for current network 365 respectively from the home network (not shown here) and the current network (not shown here) when the cellular phone 300 registers with the home network and the current network.

The communication application 317 includes a network detection application 319, a network selection application 321, and a network registration application 323. Cellular networks i.e., networks operated by different service providers operate over different frequency bands. Once the communication application 317 gets triggered, the network detection application 319 directs a radio 353 of a wireless interface 351 of the cellular phone to tune receive frequency of the radio 353 over all the frequency bands in order to detect presence of available networks. The radio 353, on detecting a cellular network retrieves network related information corresponding to the detected cellular network and forwards the network related information to the network selection application 321. The network related information is one or more of a quality of signal received by the radio 353 from the detected cellular network, data rate supported by the detected cellular network, call cost in the detected cellular network etc. The network detection application 319 communicates with the radio 353 using operating system 315 and wireless upstream interface 351 of the cellular phone 300.

The network selection application 321 uses the network related information and the network selection criterion 367 stored in the storage 361 to select a network from networks detected by the radio 353. The network selection criterion 367, for example and without limitation, includes a rule for selecting a network that has best quality of receive signal among the detected networks. In another embodiment the rule is to select a network that gives best combination of cost and supported data rate among the detected networks. In yet another embodiment the rule is to select a network that gives best combination of cost and quality of receive signal strength among the detected networks. The network selection application 321 selects a network from the networks detected by the radio 353 and informs the radio 353 about the selection. The network selection application 321 communicates with the radio 353 using the operating system 315 and the wireless upstream interface 351.

The network registration application 323 directs the radio 353 to send a network access request to the selected network via current network if the selected network is different from the current network i.e., the network with which the cellular phone 300 is currently attached. The radio 353 forwards response to the network access request to the network registration application 323. If the response corresponds to an access grant, the network registration application 323 uses the registration information for the current network 365 and the registration information for the home network 363 to determine if the current network is the home network of the cellular phone 300. The network registration application 323 directs the radio 353 to send a phone number retention request to the current network if the current network is the home network prior to detaching from the current network. The network registration application 323 further directs the radio 353 to tune receive frequency and transmit frequency of the radio 353 to the selected network and attach with the selected network. The radio 353 sends a phone number porting request and the phone number of the cellular phone 300 to the selected network, directed by the network registration application 323, if the selected network is not the home network of the cellular phone 300. The network registration application 323 communicates with the radio 353 using the operating system 315 and the wireless upstream interface 351.

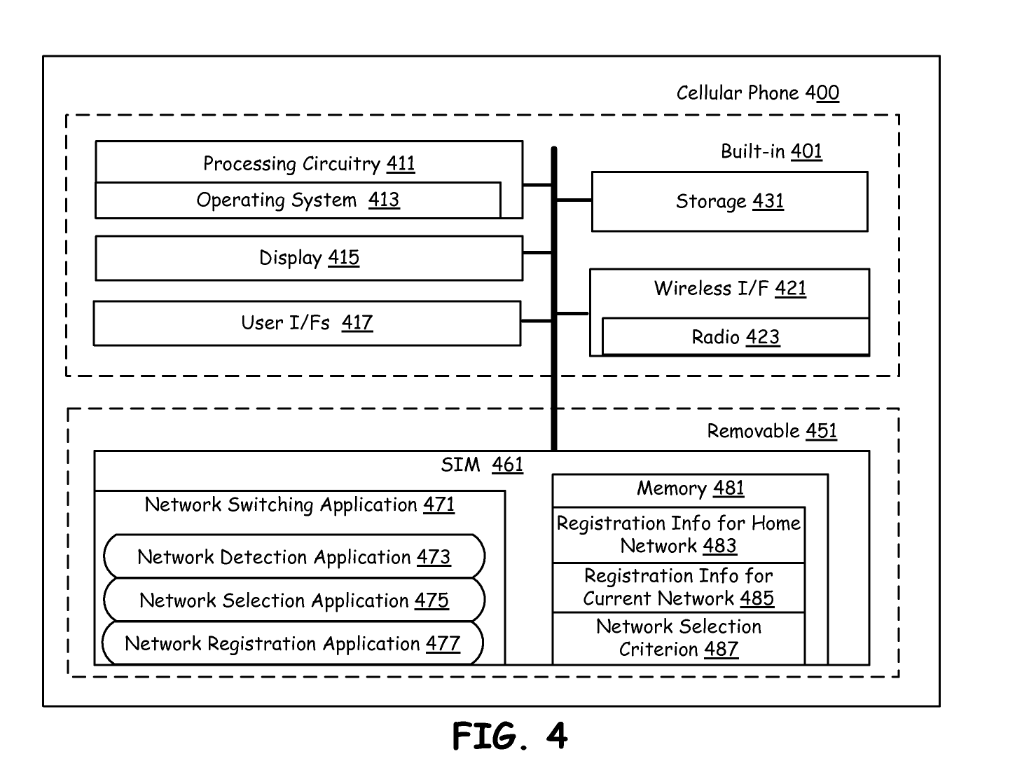

FIG. 4 is a schematic block diagram illustrating a plurality of components of a cellular phone 400 and a removable Subscriber Identity Module (SIM) 451 that includes a network switching application, the SIM 461 when plugged into the cellular phone enables the cellular phone to switch between cellular service providers without changing cellular phone number by using a network switching application of the SIM. The SIM 461 of the cellular phone 400 includes a network switching application 471, the SIM 461 when plugged into the cellular phone 400 enables the cellular phone 400 to switch between cellular service providers without changing cellular phone number by using the network switching application 471 on the SIM 461. The cellular phone 400 includes a built-in part 401 and the removable part 451. The built-in part 401 includes a processing circuitry 411, an operating system 413, a display 415, a user interface 417, a wireless upstream interface 421, a radio 423, and storage 431. The removable part 451 includes the SIM 461. The SIM 461 is issued by a network service provider to the cellular phone 400. Network operated by the network service provider who issues the SIM 461 will henceforth be referred to as home network. The SIM 461 includes a memory 481 that stores registration information for the home network 483. The SIM 461 is plugged into the cellular phone 400 and the radio 423 on the cellular phone 400 uses the registration information for the home network 483 to attach with the home network. As an example and without limitation the registration information 483 includes a phone number i.e., a unique identity of a subscriber in the home network. The cellular phone 400 is reached by other cellular phones and PSTN phones by dialing the phone number.

The SIM 461 includes a network switching application 471 that enables the cellular phone 400 to switch from one service provider to another service provider while using the phone number issued by the home network throughout. The subscriber operating the cellular phone 400 triggers the network switching application 471 using the user interface 417 of the cellular phone 400. The network switching application 471 includes a network detection application 473, a network selection application 475, and a network registration application 477. The network detection application 473 directs the radio 423 to search for available networks. The network selection application 475 uses network selection criterion 487 stored in the memory 481 of the SIM 461 and result of search performed by the radio 423 to select a network from the available networks. If the selected network is different from current network, i.e., the network with which the cellular phone 400 is currently attached, the network registration application 477 directs the radio 423 to send attachment request to the selected network, to send detachment notice to the current network if the attachment request is granted followed by sending a number porting request to the selected network. The radio 423 is further directed to send a number retention request to the current network if the current network is the home network of the cellular phone 400. The radio 423 on the cellular phone 400 receives registration information from the selected network upon attaching with the selected network. The registration information, for example, includes an identification number that is used by the selected network to identify the cellular phone 400. The network registration application 477 stores the registration information in registration information for current network 485. The cellular phone 400 registers with the selected network and accesses services provided by the selected network. The cellular phone 400 can be reached in the selected network by dialing the phone number. The switching of the cellular phone from one network to another network without changing the phone number is made possible by the network switching application 471 present on the SIM 461. Hardware and software of the cellular phone 400 have not been changed to enable network switching without changing phone number capability.

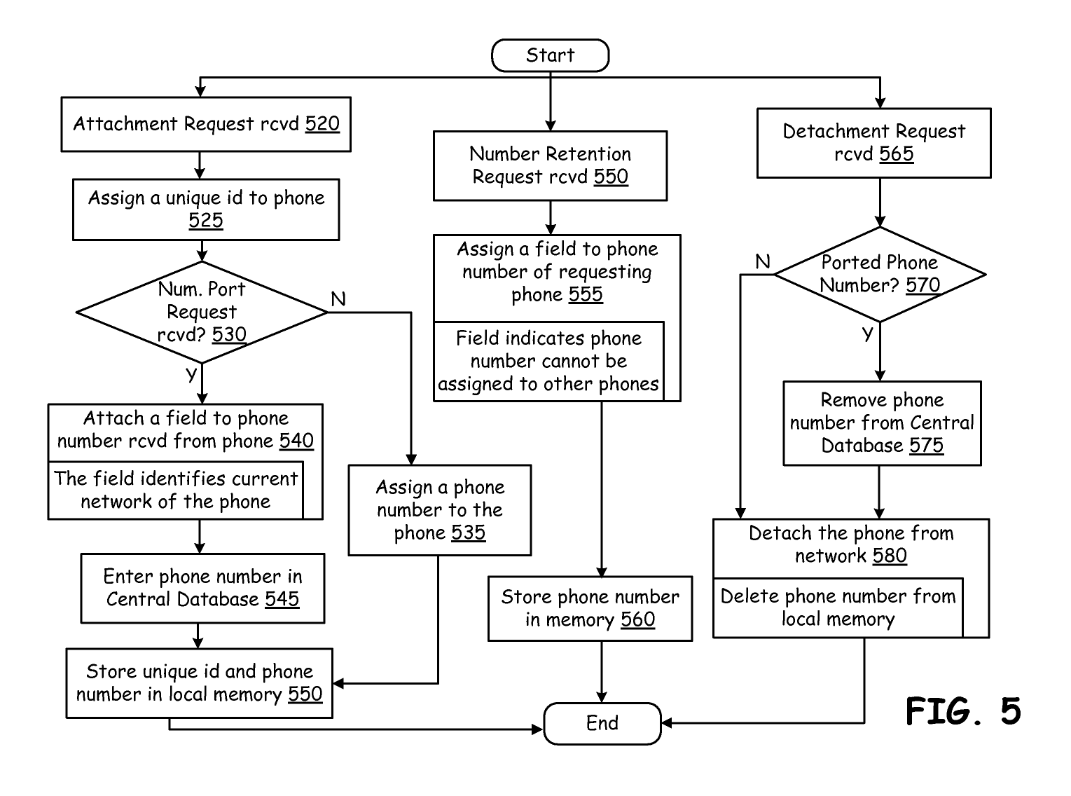

FIG. 5 is a flow chart illustrating operations of a network switch in processing a plurality of requests received from a phone that is adapted to initiate porting of a phone number while switching from a phone network to another phone network. A network switch is adapted to receive requests from phones that are attached to a phone network. The phone network is one of a wireless network and a wired network. The network switch is communicatively coupled to the phones either directly or via access points. The network switch is communicatively connected to a central database that stores phone numbers that have been ported to other networks and network identifications of networks to which phones corresponding to the ported numbers are currently attached. A call originating at a phone that is attached to the phone network goes to the network switch. The network switch looks into the central database to determine if dialed phone number is a ported number or not. If the central database has an entry corresponding to the dialed phone number, the network switch retrieves network identification of network to which phone corresponding to the dialed phone number is currently attached. The network switch forwards the call to a switch of the network using the retrieved network identification. If the central database does not have an entry corresponding to the dialed phone number, the network switch determines that the phone corresponding to the dialed phone number is currently attached to home network of the phone. The dialed phone number includes a field that identifies the home network of the phone. The network switch uses the field to forward the call to a switch of the home network.

The network switch is further adapted to receive requests from other phones that are currently not attached to the phone network via one or more of, for example and without limitation, following methods; other switches of other networks to which the other phones are currently attached, access points of the phone network wherein the access points receive the requests from the other phones via special signaling channel. For example, from a start, the network switch receives an attachment request from a phone that is currently not attached to the phone network in a step 520. The network switch grants attachment to the phone. The network switch assigns a unique identification to the phone and sends the unique identification to the phone in a step 525. Henceforth the phone communicates with the phone network using the unique identification assigned by the network switch. In a step 530 the network switch determines if the network switch has received a number porting request from the phone. If the network switch does not receive a number porting request, the network switch assigns a phone number to the phone in a step 535 and stores the unique identification of the phone and the phone number in a local memory as illustrated in a step 550. The local memory refers to a memory that is local to the phone network. If the network switch receives a number porting request from the phone, the network switch goes to a step 540. A number porting request from the phone is accompanied by a phone number of the phone. In a step 540 the network switch attaches a field to the phone number received from the phone. The field is an identification for the phone network i.e., the phone network to which the phone is currently attached. The network switch enters the phone number with the attached field in the central database in a step 545. The step 545 ensures that a call for the phone originating at another phone of another network gets routed to the network switch by another switch of the other network, wherein the another switch retrieves identification of current network of the called phone from the central database. The network switch stores the unique identification and the received phone number in the local memory of the phone network in the step 550. The unique identification and the phone number are used by the phone network to communicate with the phone as long as the phone remains attached to the phone network.

The network switch receives a number retention request from a phone in a step 550. The number retention request is received when the phone that is currently attached to the phone network intends to switch to another phone network and intends to use the phone number that the phone uses in the phone network in the another phone network. The network switch, in response to the number retention request, attaches a field to the phone number in a step 555. The field indicates that the phone number is not to be assigned to phones in the phone network. The network switch stores the phone number with the attached field in a memory of the phone network in a step 560.

The network switch receives a detachment request from a phone in a step 565. The network switch identifies if phone number used by the phone requesting detachment is a ported number in a step 570. If the phone number is not a ported number, the network switch detaches the phone from the phone network and subsequently deletes the phone number from a local memory in a step 580. The local memory refers to a memory that is local to the phone network. In an embodiment of the present invention the local memory is co-located with the network switch. If the phone number is a ported number, there is an entry corresponding to the phone number in the central database indicating that the phone is currently attached to the phone network. The network switch deletes the phone number from the central database in a step 575 in addition to deleting the phone number from the local memory in a step 580.

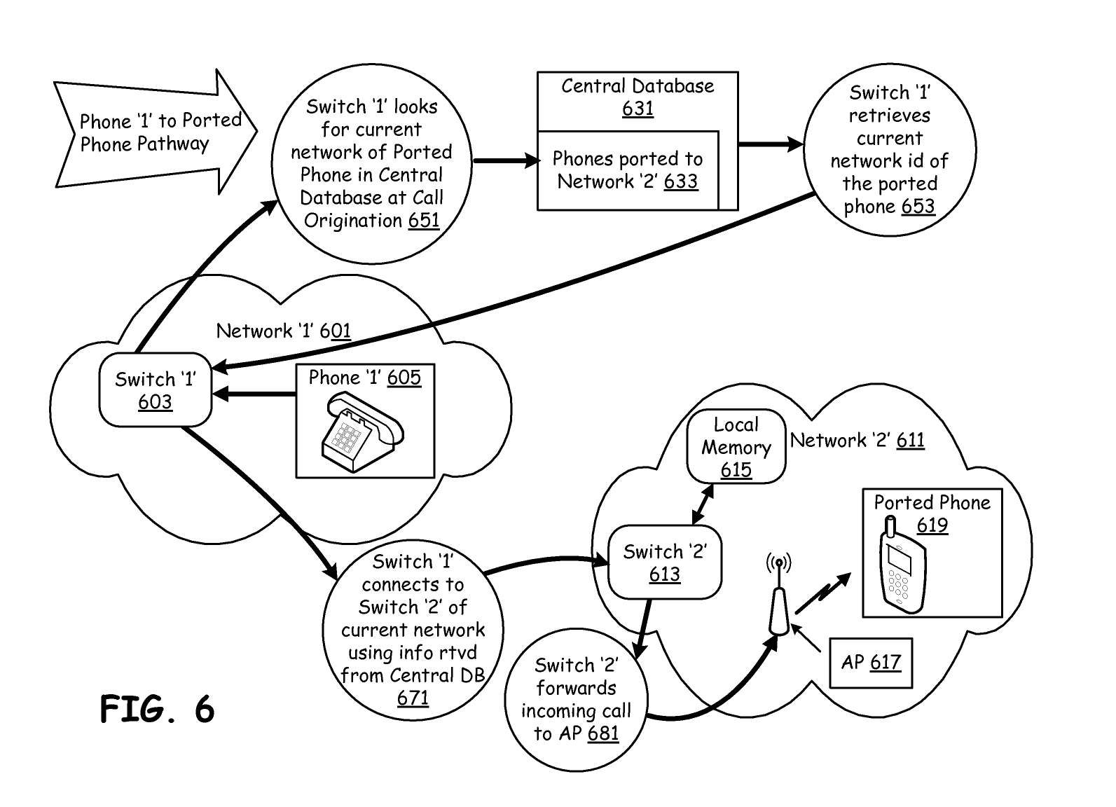

FIG. 6 is a flow chart illustrating operations supporting routing pathway of an incoming call to a ported phone. A first network 601 includes a first switch 603. A first phone 605 is attached to the first network 601 and calls originating at the first phone 605 and incoming calls for the first phone 605 are routed via the first switch 603. A second network 611 is a cellular phone network. The second network 611 includes a second switch 613, a local memory 615, and an access point 617. A ported phone 619 is currently attached to the access point 617 of the second network 611. The ported phone 619 uses a phone number in the second network 611, wherein the phone number was assigned to the ported phone by a home network other than the second network 611. The ported phone 619 ported the phone number from the home network to the second network 611 while switching association from the home network to the second network 611. In one embodiment of the present invention the first network 601 is the home network. A central database 631 is a repository that stores phone numbers of phones that have been ported to other networks i.e., the phones that switched network association without changing phone numbers. A network infrastructure shown in FIG. 6 includes the first network 601, the second network 611, and the central database 631. The central database 631 is communicatively coupled to the first network 601 and the second network 611 via a backbone network (not shown here). The first network 601 supports at least one of a fixed phone network and a cellular phone network.

The first phone 605 knows the phone number that the phone 619 uses while the phone 619 is associated with the home network of the phone 619. The first phone 605 is neither aware of the network with which the phone 619 is currently attached nor aware of the fact that the phone 619 has ported the phone number from the home network to current network i.e., the second network 611. The first phone 605 dials the phone number in order reach the phone 619. Call originating at the first phone 605 goes to the first switch 603. The first switch 603 looks for the dialed phone number in the central database 631 in a step 651. The central database 631 includes the phone number of the phone 619 and network identification for the second network 611 as the phone 619 is a ported phone. The first switch 603 retrieves the network identification of the current network of the ported phone 619 in a step 653. The first switch 603 forwards the call originating at the first phone 605 to the second switch 613 using the network identification retrieved from the central database 631. The second switch 613 retrieves identification of an access point to which the ported phone 619 is currently attached from the local memory 615 of the second network 611. The second switch 613 in a next step 681 forwards the call to the access point 617 which forwards the call to the ported phone 619 via a wireless link. The calling phone i.e., the first phone 605 in spite of being unaware of current network association of the phone 619 reaches the phone 619 using information stored in the central database 631.

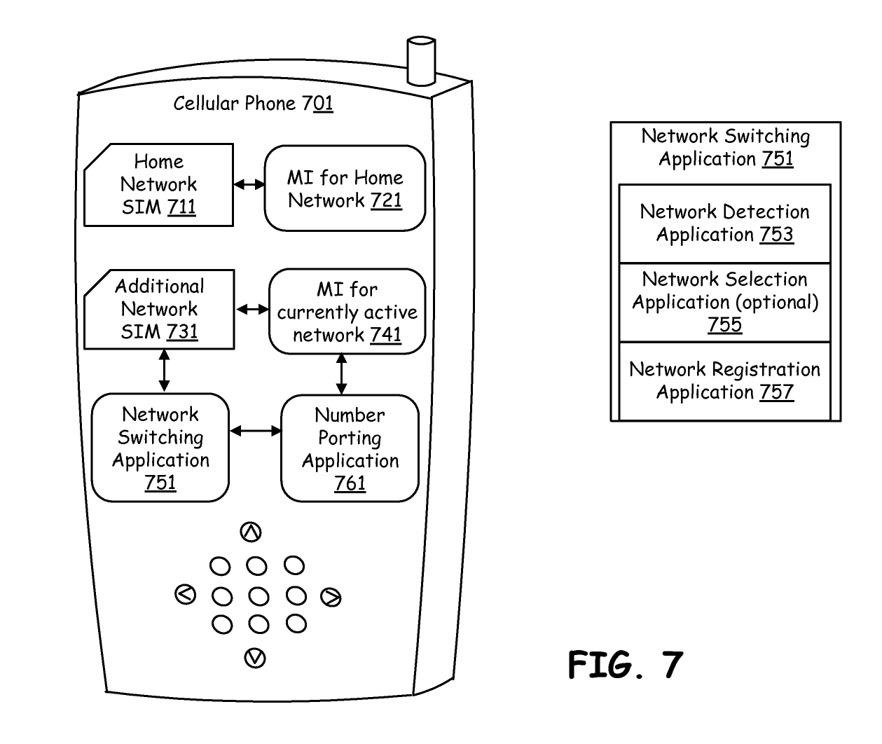

FIG. 7 is a block diagram illustrating a cellular phone having a first SIM that is used by the cellular phone to access a home network using a home phone number and a second SIM that enables the cellular phone to access another network using the home phone number. The cellular phone 701 includes the first SIM 711 that is used by the cellular phone 701 to access home network using a home phone number and the second SIM 731 that enables the cellular phone to access another network using the home phone number. The cellular phone 701 registers with a network and receives a phone number from the network upon registration. The network will henceforth be referred to as home network and the phone number as home phone number.

Upon registration, the cellular phone 701 is permitted to access services provided by the home network using the home phone number. The cellular phone 701 is further adapted to 1) change network attachment without disassociating from the home network and to 2) change network association. In case of change in network attachment without disassociation from the home network, the cellular phone 701 detaches from the home network, attaches with another network and accesses services provided by the other network using the home phone number. Call routing to and from the cellular phone 701 is supervised by a home switch of the home network. In case of change in network association, the cellular phone 701 disassociates from the home network, gives up the home phone number, registers with another network, and receives another phone number from the other network. The cellular phone 701 accesses services provided by the other network using the another phone number. Call routing to and from the cellular phone 701 is managed by another switch of the other network. In the present embodiment the cellular phone 701 is further adapted to 3) change network association without changing phone number i.e., the cellular phone 701 disassociates from the home network, registers with another network and accesses services provided by the other network using the home phone number. Call routing is managed by another switch of the other network. Process of changing/switching network association without changing phone number is initiated by the cellular phone 701 and controlled by the cellular phone 701 and the another switch.

The cellular phone 701 includes two slots/ports for plugging subscriber identity module (SIM) into the cellular phone 701. The first SIM 711 is issued by the home network and will henceforth be referred to as home network SIM. The home network SIM 711 when plugged into first of the two slots of the cellular phone 701 enables the cellular phone 701 to register with the home network and access services provided by the home network. The cellular phone 701 uses a home phone number and a mobile identification (MI) for the home network 721 to access the services. The services include one or of a combination of a voice call service, data communication service, short message service etc. The home network SIM 711 typically stores the MI for the home network 721.

The second SIM 731 is used by the cellular phone 701 to register with another network and access services provided by the other network using the home phone number and a MI for the other network 741. The second SIM 731 will henceforth be referred to as additional network SIM. The additional network SIM 731 includes a network switching application 751 and a number porting application 761. The network switching application 751 is software that enables the cellular phone 701 to switch association from the home network to the other network. The number porting application 761 is a software that enables the cellular phone 701 to access services provided by the other network, to which the cellular phone 701 switched using the network switching application 751, using the home phone number thereby keeping switching of network by the cellular phone 701 oblivious to other users/phones.

A user plugs in the home network SIM 711 in the first slot of the cellular phone 701 at a first time. The cellular phone 701 using information stored in the home network SIM 711 attaches with an access point of the home network. At a second time the user removes the home network SIM 711 from the first slot and plugs in the additional network SIM 731 into the second slot of the cellular phone 701. The network switching application 751 and the number porting application 761 that are firm wired into the additional network SIM 731 get triggered. The network switching application 751 includes a network detection application 753 that directs a radio on the cellular phone 701 to look for available networks by scanning over a pre-defined band of frequencies. The radio returns result of the scanning to the network detection application 751. The network switching application 751 includes a network selection application 755 that selects a network from networks detected by the network detection application 753 based on network selection criterion. The network selection criterion is a plurality of rules stored in the additional network SIM 731. As an example and without limitation, the network selection application 755 selects a network from the detected networks, using the network selection criterion, in following order of preference: 1) best combination of receive signal strength and call cost, 2) minimum call cost, 3) maximum supported data rate, 4) best combination of receive signal strength and supported data rate. In one embodiment the network detection application 753 directs a screen on the cellular phone 701 to display the networks detected by the network detection application 753. A user of the cellular phone 701 enters a choice using a user input interface of the cellular phone 701. The network switching application 751 further includes a network registration application 757 that directs the cellular phone 701 to register with the selected network, selected by either the network selection application 755 or the user in a previous step and disassociate from the home network.

The number porting application 761 operates in conjunction with the network registration application 757 to enable porting of the home phone number. The number porting application 761 sends a number retention request to the home network via the radio before the cellular phone disassociates from the home network. The radio, triggered by the network registration application 757, sends an association request to the selected network. In response to the association request, the radio receives mobile identification (MI) 741 from the selected network. The number porting application 761 directs the radio to send a number porting request and the home phone number to the selected network. In response to the number porting request, the selected network, instead of assigning a new phone number to the cellular phone 701, uses the home phone number to communicate with the cellular phone 701. The cellular phone 701 registers with the selected network, disassociates from the home network, and accesses services provided by the selected network using the home phone number and the MI 741.

The user of the cellular phone 701 at a third time triggers the network switching application 751. The user does so 1) via the user input interface of the cellular phone 701 or 2) by pulling out the additional network SIM 731 from the second slot and plugging the additional network SIM 731 back into the second slot. The network detection application 753 searches for available networks. The network selection application 755 selects a network, based on network selection criterion, from the available networks. As a way of example the user selects a network that is different from network with which the cellular phone 701 is currently attached or was most recently attached. The network registration application 757 and the number porting application 761 on the additional network SIM 731 direct the cellular phone 701 to switch association and get attached with the network selected by the user and direct the selected network to associate the cellular phone 701 with the home phone number of the cellular phone 701 such that the cellular phone 701 continues to use the home phone number in the selected network. Depending on SIM that is plugged into the cellular phone 701, the cellular phone 701 attaches with the home network or another network, wherein the other network is selected from a plurality of available networks by the cellular phone 701 or the user. Irrespective of network with which the cellular phone 701 is currently attached, the cellular phone 701 is reached by other phones by dialing the home phone number of the cellular phone 701.

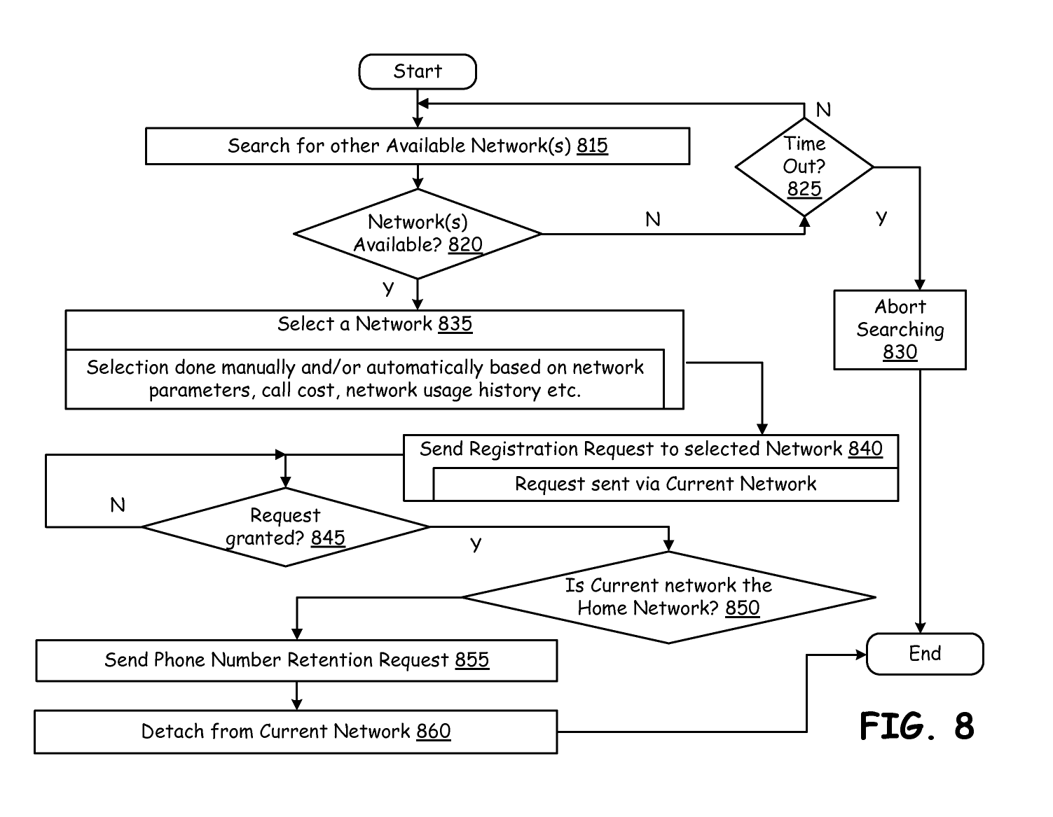

FIG. 8 is a flow chart illustrating a method for retaining a phone number used in home network while switching from a current network to another network. The method starts at a step 815 with the phone searching for available phone networks. The phone is a wireless phone or a fixed line phone. The phone supports one or more of a cellular communication protocol, satellite communication protocol, PSTN protocol etc. The searching for available phone networks is for example and without limitation is triggered manually. The phone includes a special key/switch or an icon which when selected directs the phone to search for available phone networks. In another embodiment the phone does not search for available networks but retrieves a plurality of network identifications corresponding to available networks from a database upon selection of the special key or the icon.

In response to searching for available networks, the phone determines whether any network(s) are available at step 820. If not, operation proceeds to step 825 where it is determined whether a timeout criterion has been met. If the searching of step 815 has timed out, searching is aborted at step 830 and operation ends. However, if one or more networks is/are available, operation proceeds to step 835 where the phone selects a network from a plurality of available networks returned by the searching step 815. The phone selects the network based on network parameters of the plurality of available networks, for example, receive signal quality, supported data rate, supported features etc., call cost, network usage history etc. For example the phone selects a network with which the phone has been attached most frequently if the plurality of available networks has identical receive signal strength and supported data rate. In yet another embodiment the selection of the network is performed by the user. In a next step 840 the phone sends a registration request to the selected network via the current network i.e., the network with which the phone is currently attached. The phone determines if the current network is the home network of the phone once the registration request in granted by the selected network in a step 845. The phone is uniquely identified by a phone number.

A network which issues the phone number to the phone is referred to as home network of the phone. The phone sends a phone number retention request to the current network in a step 855 if the current network is the home network of the phone. In a next step 860 the phone detaches from the current network. The phone detaches from the current network in a step 860 after receiving registration grant message from the selected network if the current network is not the home network of the phone. The phone number retention request step guarantees that the home network does not issue the phone number to other phone even when the phone is not attached with the home network.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “operable to” indicates that an item includes one or more of power connections, input(s), output(s), etc., to perform one or more its corresponding functions and may further include inferred coupling to one or more other items. As may still further be used herein, the term “associated with,” includes direct and/or indirect coupling of separate items and/or one item being embedded within another item. As may be used herein, the term “compares favorably,” indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A phone infrastructure, the phone infrastructure comprising:
a plurality of phone networks that are communicatively coupled via a backbone network;
a central database that is communicatively coupled to the backbone network, the central database storing ported phone numbers;
a phone comprising a phone number porting application;
the phone associating with a first of the plurality of phone networks, the phone being assigned a phone number by the first of the plurality of networks upon association;
the phone retaining the phone number after disassociating from the first of the plurality of phone networks by using the phone number porting application;
the phone directing a second of the plurality of phone networks to identify the phone by the phone number upon association of the phone with the second of the plurality of phone networks by using the phone number porting application; and
the phone further directing the second of the plurality of phone networks to enter the phone number and an identification corresponding to the second of the plurality of phone networks in the central database.

2. The phone infrastructure of claim 1, wherein the phone uses the number porting application to further direct the first of plurality of home networks to reserve the phone number after the phone disassociates from the first of plurality of home networks.

3. The phone infrastructure of claim 1, wherein:
the phone switches association from the second of the plurality of phone networks to a third of the plurality of phone networks; and
directs the third of the plurality of phone networks to identify the phone by the phone number assigned by the first of the plurality of phone networks.

4. The phone infrastructure of claim 1, wherein the phone directs the second of the plurality of phone networks to remove the phone number and the identification corresponding to the second of the plurality of phone networks from the central database.

5. The phone infrastructure of claim 1, wherein the phone directs the third of the plurality of phone networks to enter the phone number and an identification corresponding to the third of the plurality of phone networks in the central database.

6. The phone infrastructure of claim 1, wherein the phone number porting application is triggered when the phone switches network association.

7. A subscriber identity module, the subscriber identity module comprising:
a communication application;
a storage that stores a service-subscriber key;
an application program interface that enables the communication application to interact with a phone when the subscriber identity module is plugged into the phone; and
the communication application enabling the phone to retain phone number used in a first network when the phone switches association from the first network to a second network.

8. The subscriber identity module of claim 7, wherein the communication application enables the phone to detect a plurality of available networks.

9. The subscriber identity module of claim 7, wherein the communication application enables the phone to select a network from the plurality of available networks based on network selection criterion.

10. The subscriber identity module of claim 7, wherein the network selection criterion is stored in the storage of the subscriber identity module.

11. The subscriber identity module of claim 7, wherein the communication application directs the phone to retrieve the network selection criterion from a remote storage.

12. A method performed by a phone that is switching association from a first phone network to a second phone network, the phone being identified by a phone number, the phone comprising a number porting application wherein the first phone network and the second phone are communicatively coupled to a central database that stores ported phone numbers, the method comprising:
the phone sending a number retention request to the first phone network, if the phone number is assigned to the phone by the first phone network;
the phone directing the first phone network to remove entry corresponding to the phone from the central database if the phone number is not assigned to the phone by the first phone network;
the phone directing the second phone network to enter an entry corresponding to the phone in the central database upon association of the phone with the second phone network; and
the phone directing the second phone network to use the phone number for identifying the phone until the phone remains associated with the second phone network.

13. The method of claim 12, wherein a subscriber-identity module comprises the number porting application and the phone interacts with the number porting application if the subscriber-identity module is plugged into the phone.

14. A phone having a radio, a processing circuitry, a memory and a user input interface, the phone comprising:
a first slot for inserting a first subscriber-identity module;
a second slot for inserting a second subscriber-identity module;
a communication application that interacts with one of the first and the second subscriber-identity modules;
the phone attaches to a phone network in pursuance to direction from subscriber-identity module with which the communication application interacts.

15. The phone of claim 14, wherein the communication application selects one of the first and the second subscriber-identity modules for interaction based on a user input entered via the user input interface of the phone.

16. The phone of claim 14, wherein the communication application interacts with the second subscriber-identity module in absence of the first subscriber-identity module in the first slot;
